(19) United States
(12) Patent Application Publication
(10) Pub. No.: US 2011/0117890 A1
(43) Pub. Date: May 19, 2011

(54) TOP LIST GENERATED FROM USER CONTEXT BASED INFORMATION

(75) Inventors: Lars-Gunnar LUNDGREN, Bjarred (SE); Jonas OLSSON, Helsingborg (SE)

(73) Assignee: Sony Ericsson Mobile Communications AB, Lund (SE)

(21) Appl. No.: 12/620,638

(22) Filed: Nov. 18, 2009

(51) Int. Cl. H04M 3/42

(52) U.S. Cl. 455/414.1

(57) ABSTRACT

The invention relates to a system for providing a list to a mobile communication device, wherein the system comprises a mobile communication device and a server. The mobile communication device comprises a first list of parameters of the activity in the mobile communication device, and wherein the server comprises a second list of parameters of activities of a number of second mobile communication devices, and wherein the mobile communication device is adapted to transmit the first list to the server. The server is adapted to receive the first list, wherein the server is adapted to analyse the first list in relation to the second list, wherein the server is adapted to derive a third list based on the analysis, and wherein the mobile communication device is adapted to receive the third list.

### TECHNICAL FIELD

The present invention relates to the field of mobile communication devices and, in particularly, to the field of gathering and using context based information for generating a top list of downloadable applications.

### BACKGROUND

Making applications for modern mobile communication devices are today quit simple. This, together with a growing need for new nifty applications which might facilitate the user in his or hers everyday life, has lead to a huge market for downloadable applications.

When a user connects with his or hers mobile communication device to a server who's offering downloadable applications, he or she is often confronted with the ordeal of having to brows through a huge amount of applications before finding the application or applications the user is really interested in. To remedy the problem of having to brows through a waste amount of applications, the application service providers often provides top lists which ranks the currently most popular application based on parameters such as the highest user rating or the most downloads.

However, many times these provided top lists do not help the user in finding the right application for his or hers need, since the user's need and preference in applications may not coincide with the preference of that of the general users'. Thus, finding a way to provide a top list that matches the individuals' preference, and in that way helping the user to find the right application is therefore highly sought for.

### SUMMARY OF THE INVENTION

With the above description in mind, then, an aspect of the present invention is to provide a user with information in the form of a list which content is based on the users' daily usage of his or hers mobile communication device.

An aspect of the present invention relates to a system for providing a list to a mobile communication device, wherein the system comprises a mobile communication device and a server, and wherein the mobile communication device comprises a first list of parameters of the activity in said mobile communication device, wherein the server comprises a second list of parameters of activities of a number of second mobile communication devices, wherein the mobile communication device is adapted to transmit the first list to the server, wherein the server is adapted to receive said first list, wherein the server is adapted to analyse said first list in relation to said second list, wherein the server is adapted to derive a third list based on said analysis, and wherein the mobile communication device is adapted to receive said third list.

In the system the third list may comprise features that can be supplied from the server.

In the system the parameters may comprise the frequency of the usage of one or more features.

In the system the feature may be an application to be executed in a mobile communication device.

In the system the information from the first list may be added to the second list.

The system may further comprising a second server, wherein the server is adapted to transmit the third list to the second server, and wherein said second server is adapted to update said third list.

The system may further comprising a third server, wherein the server is adapted to transmit a result of the analysis to the third server, wherein said third server is adapted to derive the fourth list based on said analysis of said result, and wherein said third server is adapted to transmit the fourth list to said mobile communication device.

A second aspect of the present invention relates to a server for deriving a list, wherein the server is adapted to receive a first list of parameters of activities from a mobile communication device, wherein the server comprises a second list of parameters of activities of a number of second mobile communication devices, said server is adapted to analyse said first list in relation to said second list, said server is adapted to derive a third list based on said analysis, wherein said server is adapted to transmit said third list.

The server may further be adapted to add information from the first list to the second list.

A third aspect of the present invention relates to a method for a providing a list in a system comprising a mobile communication device and a server, the mobile communication device generates a first list of parameters of the activity in said mobile communication device, the mobile communication device transmits the first list to the server, the server receives said first list, the server analyses said first list in relation to a said second list comprising parameters of activities of a number of second mobile communication devices, the server derives a third list based on said analysis, and the mobile communication device receives said third list.

In the method said third list may comprise features that can be supplied from the server.

In the method said parameters may comprises the frequency of the usage of one or more features.

In the method said feature may be an application to be executed in a mobile communication device.

In the method information from the first list may be added to the second list.

In the method the system may further comprising a second server, wherein the server transmits the third list to the second server, wherein said second server updates said third list.

In the method the system may further comprising a third server, wherein the server transmits a result of the analysis to the third server, wherein said third server derives the fourth list based on said analysis of said result, and wherein third server said transmits the fourth list to said mobile communication device.

### BRIEF DESCRIPTION OF THE DRAWINGS

Further objects, features, and advantages of the present invention will appear from the following detailed description of some embodiments of the invention, wherein some embodiments of the invention will be described in more detail with reference to the accompanying drawings, in which:

FIG. 1 illustrates a generic mobile communicating device, in this case a mobile phone, according to an embodiment of the present invention; and

FIG. 2 illustrates, using a block scheme, an example of how a monitoring application in a mobile communication device collects context information from features in the device, and transmits the collected context information to a server which then compiles and sends a top list based on context information to the mobile communication device which displays it on the screen of the device; and

FIG. 3 illustrates how collected context information in mobile communication devices may be shared amongst a number of other mobile communication devices and servers; and

FIG. 4 shows an example of a display screen of a context information generated top list displayed on display screen of the users' mobile communication device.

### DETAILED DESCRIPTION

Embodiments of the present invention relate, in general, to the field of monitoring and gathering context based information for generating and providing a top list of downloadable applications to a user. Embodiments of the present invention relates to a mobile communication device, such as a mobile phone. However, it should be appreciated that the invention is as such equally applicable to electronic devices in general, which do not include any radio communication capabilities. However, for the sake of clarity and simplicity, most embodiments outlined in this specification are related to mobile phones.

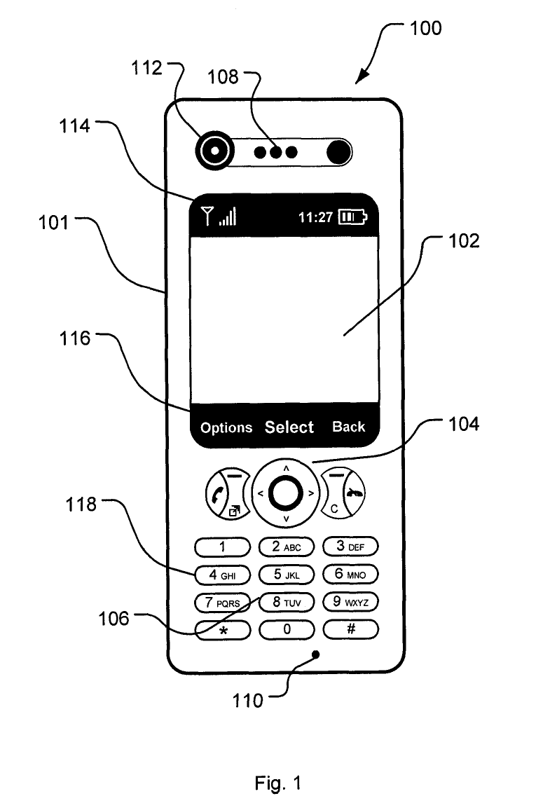

FIG. 1 shows an example of a mobile communication device 100 in the form of a mobile phone. The figure shows a front side view of the mobile phone 100 comprising a front portion of the casing 101, a display area 102, and means 104 for navigating among items (not shown) displayed in the display area. The display area 102 may comprise a status indication area 114 and one or more softkey bars 116. The status indication area 114 may for example include symbols for indicating battery status, reception quality, speaker on/off, present mode, time and date, etc. The status indication section is not in any way limited to include the symbols and the functions presented herein. The softkey bar 116 is operable using the navigation means 104 or, if using a touch sensitive screen, by tapping the softkey directly with a pen-like object, a finger, or other body part. The functions of the softkeys are not limited by the functions indicated in the figure. Neither are the placements of the softkey bar 116 and the status indication area 114 limited to be placed at the bottom and the top of the screen, as shown in the example. The navigation means 104 can be a set of buttons, a rotating input, a joystick, a touch pad, a multidirectional button, but can also be implemented using a touch sensitive display, wherein the displayed items directly can be tapped by a user for selection, or be voice activated via a headset or a built-in microphone. The mobile phone 100 can also comprise other features normally present in such a device, such as a keypad 106 comprising several individual buttons 118, a speaker 108, a microphone 110, a front camera unit 112, a processor (not shown), a memory (not shown), one or more accelerometers (not shown), a GPS unit (not shown), a vibration device (not shown), an AM/FM radio transmitter and receiver (not shown), a digital audio broadcast transmitter and receiver (not shown), etc. The mobile phone 100 is capable of downloading, and executing, application from a remote server. Applications are capable of presenting information in the display area 102.

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference signs refer to like elements throughout.

One way of solving, or at least mitigating, the issues described in the background section above is to gather different kinds of context based information based on how different features, such as applications and functions, in the mobile phone is used, and to use that knowledge to generate one or more relevant top lists for the user. For example, a person who spends much of his free time on the golf course wants to know if there are any new cool applications to be downloaded. He accesses the network and navigates to an application service provider. When he accesses the application service provider, context based information regarding his usage of his mobile phone and his usage of the mobile phone applications, are transmitted to the application service provider's server. The server then analysis the received context based information and from the result of the analysis compiles a suitable top list of downloadable applications. The top list is then sent from the server back to the users' mobile communication device, and is displayed on the screen of the mobile communication device. The context based information that was sent to the application service provider may in this case for instance be GPS information (which places him on the golf course), times and dates (which shows that he is often at the golf course), and that his favourite applications to use are a golf score application and golf course map application. All these context based information will characterise him as a typical golf lover. The server at the application service provider, which receives the context based information, will then determine through an analysis that the user can be characterised as a golf lover. Then the server will generate a top list containing for instance the ‘most downloaded applications’ of all other golf lovers in the world. In this way the user gets a top list of applications which is more tailored to his interests and needs, thus eliminating the need for searching and browsing through hundreds of other applications. The present invention, which was briefly described above through the example with the golfer, will now be explained in more detail.

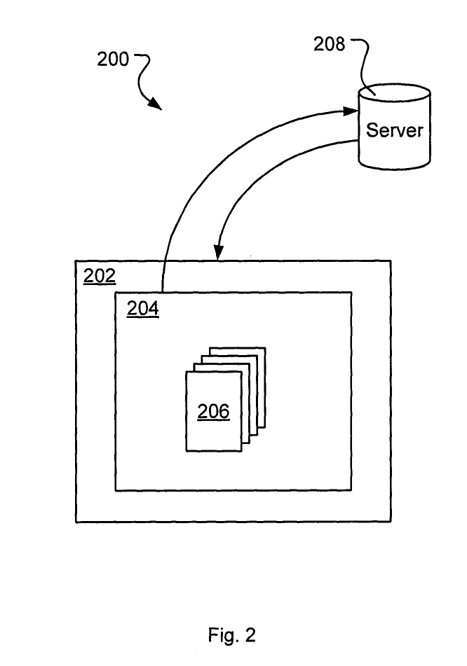

FIG. 2 illustrates, using a block diagram, an embodiment of the present invention. The invention may, in an embodiment, generally be described as a system 200 for providing a list to a mobile communication device 202, where the system 200 consists of a mobile communication device 202 and a server 208. The mobile communication device 202 generates, using information from a monitoring application 204, a first list of parameters which are based on the activity in the mobile communication device 202, such as the usage of applications and functions 206. The generated first list is then transmitted from the mobile communication device 202 to the server 208 which receives the first list. The server 202 contains a second list based on parameters of activities from a second mobile communication device or a number of other mobile communication devices which previously have communicated with the server 208 and during the communication transmitted their lists to the server 208. The server 208 receives the first list from the mobile communication unit 202 and analysis the first list in relation to the second list stored on the server 208. Based on the analysis a third list is derived at the server 208. The third list is then transmitted to the mobile communication device 202 where the content of the third list is shown to the user on a display screen in the mobile communication device 202.

In another embodiment the information in the first list is added to the second list in the server, and in that way accumulates the information from all mobile communication devices connecting to the server.

In yet another embodiment of the application the system also consists of a second server 312. The server 314 may in this embodiment transmit the third list to the second server. The second server 312 may then analyse and update the third list and then transmit the third list to the mobile communication device 302.

In yet another embodiment the system consists of a third server 310. The server 314 may in this embodiment transmit the result of its analysis of the first list to the third server 310. The third server 310 receives the result, processes it, and derives a fourth list based on said result. The third server 310 then transmits the fourth list to the mobile communication device 302.

To further explain the present invention it will now be described using examples more closely related to how the invention may be implemented in real-life. In one such real-life implementation example the block diagram in FIG. 2 shows a mobile phone (i.e. a mobile communication device) 202, communicating with a server 208, having a monitoring application 204 for monitoring features 206 running in the mobile phone 202. The monitoring application 204 collects or records context based information (i.e. parameters of activities in the mobile communication device) from different features both running and not running in the mobile communication device 202. The monitoring application 204 may either be an application running in the mobile communication device, and/or be a part of the operating system (OS) in the mobile communication device 202. A feature 206 may for instance be an application (a program), or it may be an added or built in function or functional unit, such as a GPS unit, a G-sensor unit, a Bluetooth unit, a camera unit, an accelerometer unit, a compass unit, a near field communication unit, a radio communication unit, a digital and/or analog radio unit, a touch sensitive area unit, a button unit, a temperature unit, an altitude unit, an infrared communication unit, a light unit, etc.

The collected context based information may in one version of the present invention be transmitted by the user, while in another variant be requested and retrieved by the server the user connects to.

Through out this application the term server should be interpreted as a computer program capable of delivering a service to a client. The computer program may be run on a stationary computer, a virtual computer, as well as in handheld devices (i.e. mobile phones). The term client should be interpreted as a mobile communication device or a portable computer.

In one variant of the present invention the monitoring application 204 is user activated, thus the user may self decide if the monitoring application 204 should be installed and activated or not. In another variant the monitoring application 204 is both installed and activated already during the manufacturing and preparation of the portable communication device 202, and the user is not able to turn it off. In both variants above the user may either be able to decide himself which context based information (i.e. parameters of activity in the mobile communication device) that are going to be collected and not collected.

Below is a listing of context based information that might be collected from the features 206 by the monitoring application 204 in a mobile communication device.

Usage—The context based information ‘usage’ may for instance be the number of times a specific, or a collection, of features in the device has been accessed. For example, the number of times the game Zelda has been played.
Time—The context based information ‘time’ may for instance be the total time a specific or a collection of features have been used. It may also be how long time a specific feature has been activated (totally or during a specific period), or at which time (clock time) a specific feature was used. For example, how long the total game playing time is of the game Zelda.
Date—The context based information ‘date’ may for instance be which date, or a collection of dates, a specific feature was used. For example, that the game Zelda has been played on the dates 2009-11-02, 2009-11-03, 2009-11-04, 2009-11-05, and 2009-11-06.
Location—The context based information ‘location’ may for instance be the GPS coordinates during the initiation and/or termination of a feature or it may be the GPS track (multiple points) recording during the activation of the feature. For instance, the GPS track when the game Zelda was played.
Category—The context based information ‘category’ may for instance be which category or categories, such as general application, a game, music etc., the feature in question belongs to. For example, the game Zelda belongs to the categories “games”, “classic games”, “action games”, and “adventure games”.
Share—The context based information ‘share’ may for instance be the number of times an application has been shared by the user to other users or how many times the feature has been shared amongst a group of users. For example, the game Zelda has been shared with two other users.
Activity—The context based information ‘activity’ may for instance be during which user activity the feature was used by the user. For example, the game Zelda was activated during the same time as the GPS unit recorded a movement from home to work location of the user, and the accelerometers detected rocking associated with riding a vehicle, thus making the most likely activity being that the user was riding (not driving) some kind of vehicle to work.
Roaming—The context based information ‘roaming’ may for instance be which feature was active during roaming. It may also be what networks was accessed when roaming. For example, the user was playing the game Zelda while travelling (roaming) trough three networks not including the home network.
Error—The context based information ‘error’ may for instance be the number of times a feature has generated an error in the mobile communication device or in another feature. For example, the game Zelda has generated two errors in the “Zelda” application and one error in the “incoming call” application.
Download—The context based information ‘download’ may for instance be how many times a specific feature has been downloaded or how much download data it has generated. For example, the game Zelda has been downloaded two times (initial download and one update) and has generated 89 kB of downloaded data.
Install—The context based information ‘install’ may for instance be the number of times a feature has been installed, re-installed, and/or updated. It may also be the number of times another feature that has been installed, made use or provide the feature with some kind of plug-in. For example, the game Zelda has been installed one time and updated one time. It has also installed a wallpaper in the wallpaper application.
Rating—The context based information ‘rating’ may for instance be the rating that the user of the portable communication device has given a specific feature. For example, the user has rated the game Zelda 8 out of 10.
Cooperation—The context based information ‘cooperation’ may for instance be how many other, and which, features a specific feature cooperates with during usage. For example, the game Zelda cooperates during game play with the audio output unit, the navigational unit, the display unit, the tactile feedback unit, and the accelerometer unit.

The present invention is not in any way only limited to the context based information described above. In some variants of the invention only one of the above context based information may be collected, while in another variant several or all of the context based information above may be collected by the monitoring application 204. Also, in another variant of the present invention some of the above describes context based information may be combined to form additional context based information.

The context based information of the features 206, collected by the monitoring application 204, may be sent from the mobile communication device 202 to a server 208. The context based information may be sent to the server 208 in the format of a list containing; feature specific parameters, a collection of parameters representative of a collection of features, or a single message with data of the monitored features. The server 208 then receives the context based information in the form of a list, analyse it and use it, anonymously or tied to a specific user, to derive or generate a list (a second list) containing an application top list. The derived application top list is in fact a sub set of a much larger list containing all stored applications and files on the server 208. The application top list (second list) is the sent from the server 208 to the mobile communication device 202 and displayed on the mobile communication devices display.

An example; a user has been playing the game Zelda every day, on his mobile phone, on his way to work for two months. During this time the monitoring application in the mobile phone has been gathering context based information on his activities playing the game Zelda. One day the user wants to check if there are additional levels that may be added to the game, so he connects, via his mobile phone, to an application server containing lots of game applications and files. When he connects to the application server the context based information is transmitted to the server. The server receives the information, analysis it and determines that the user likes to play the game Zelda. The server then derives an application top list customized for a typical Zelda game lover containing the top downloaded Zelda game levels. The Zelda application top list is then transmitted to the users, mobile phone and displayed on the display. The user may now brows the Zelda application top list and download, from the server, the Zelda game levels he wants to install and play. The user will in this way not be subjected to a top list containing the waste amount of applications and files on the sever, and have in this way much less, but more relevant, material presented to him

A top list may be based on and generated by the server 208 in many different ways. Below are some examples of possible top lists that might be generated by the server 208.

Top downloads—A ‘top downloads’ based top list may for instance contain the top downloaded applications in the world, country, region, city, community, among friends, at the company, and at a specific age group. For example, the top list may contain the game Zelda's top ten add-ons.
User—A ‘user’ based top list may for instance be based on parameters decided by the users themselves. For example, the top list may contain the game Zelda's top teen most impressive visual game levels.
Reliability—A ‘reliability’ based top list may for instance be based on the reliability in the form of security or crash proof applications. For example, the top list may contain the top five most stable add-ons to the game Zelda.
Usage—A ‘usage’ based top list may for instance be based on the number of times an application has been used. For example, the top list may contain the most played levels of the game Zelda.
Time—A ‘time’ based top list may for instance be based on the total time applications has been activated or the longest time the application has been activated during a single usage. For example, the top list may contain which Zelda levels that have taken the longest to play.
Update—A ‘update’ based top list may for instance be based the number of times an application has been updated or revised. For example, the top list may contain which Zelda game versions that have been updated the most.
Shared—A ‘share’ based top list may for instance be based on the number of times an application has been shared between all in the world, in a group, in a region, etc. For instance, the top list may contain the Zelda game levels that have been shared the most among players.
Feature growth—A ‘feature growth’ based top list may be based on the number of times an application has been revised, updated, or an add-on has been produced. For instance, the top list may contain which Zelda game versions that have been updated the most.
Commented—A ‘commented’ top list may be based on how many comments an application has got from people. For example, the top list may contain the most commented Zelda game levels.
Category—A ‘category’ top list may be based on how many categories or genres an application belongs to. For example, the top list may contain the number of genres adventure games like Zelda belongs to.
Preferences—The top list may also be generated depending on personal preferences only, the preferences of a specific group, or the preferences of all users.

The present invention is not in any way limited to generate top lists of the kind described above. On the contrary, several other top lists are possible, some being combination of the top lists mentioned above, and some may be based on context based information not mentioned in this application. Also, the server may generate and provide several different top lists to the user at the same time. For instance, a user may receive a “top downloads” top list, a “usage” top list, and a “shared” top list. In one embodiment the user then may switch between these top lists on the display of his mobile phone.

The collected context based information may not only be used to create top lists. The context based information may for instance be used by a service provider, a mobile phone vendor, or an operator to offer other value-added services. A value-added service may for instance be to generate recommendations of applications, recommend updates, customize advertisements, help in support issues, recommend beneficial subscriptions, recommend sites (web and real life) to visits, etc, to the customer. These value-added services may be initiated by the user by for instance ageing to receive advertisements, and/or may come as a default setting when buying the mobile phone or the mobile phone subscription.

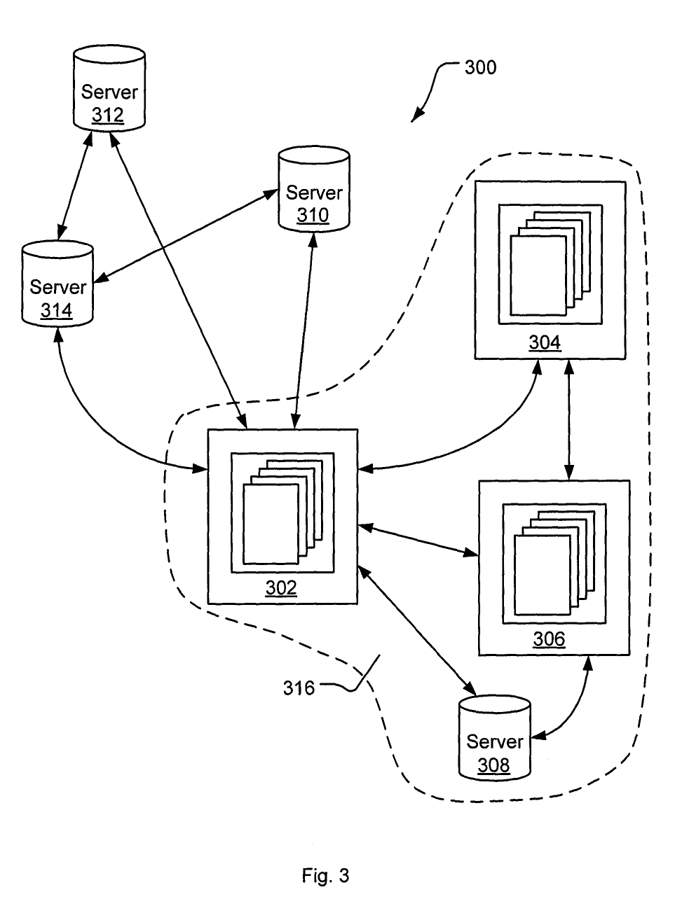

The context based information collected in one mobile communication device may in another embodiment be shared with numerous parties as shown in FIG. 3. A shown in the example of FIG. 3, the context based information collected from the mobile communication device 302 may be shared with an application server 314, another application server 310, and information gathering server 312, two of the users' friends' mobile communication devices 304,306, and a community 316 server 308.

The context based information shared with all these parties may or may not be the same. In one variant of the present invention the context based information shared within the community 316 or with the users' friends 304,306 may be more extensive than the context based information shared with other parties such as the applications servers 314,312. By sharing the context based information with ones friends, “internal” top lists may be created. For instance, if a user is a part of a gaming community 316 dedicated to the game Zelda, the user may regularly share context based information 302 with his fellow Zelda garners 304,306 and one or more community servers 308. When the user connects to the community server 308 he will get a top list based on his and the whole gaming communities context based information about the usage of the game Zelda, while if the user connects to one of his friends 304,306 may in an embodiment get a top list that is based on the users' own context based information, the context based information of the friend, and the top lists existing in the friends mobile communication device 304, 306.

Context based information transmitted from a user 302 to an application server 314 may be shared or sold to a third party (another server 310). The application server 314 may compile, analyse, transform the collected context based information from one or several users in many different ways before sharing or selling it to a third party 310. In this way the service provider, phone vendor or operator owning the application server 314 may earn money on the context based information coming from one or several users. The third party 310 may use the shared or bought context based information for their own purposes. In one embodiment the third party may use the information to target a user or a group of users with specific advertisements. The context based information may also be stored and accumulated over time in a server 314, and n this way the progress and development of a users' usage of his mobile communication device may be followed over time. This information may then be used to provide more accurate recommendations to the user.

The context based information may also help in the development of new application. The company developing new applications collects context based information from users using their applications or buys the information from an application service provider. The information may then be used to further develop the applications by for instance looking how the users actually uses the application, and identifying if there are any problems with the applications (error rate, type of error, etc.). Also, the companies may use the information as a template for developing other applications and make them more appealing to the user.

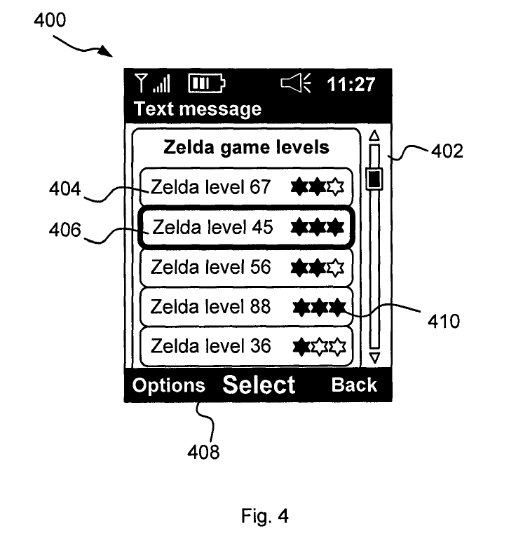

FIG. 4 shows an example of a display area 102,402 of a mobile communication device which has received a top list based on context based information 400. The display area 402 is in this example displaying a most downloaded “Zelda game levels” top list which is based on the number of times each Zelda game level has been downloaded by other users. The top most downloaded game level 404, in this case the “Zelda level 67”, is displayed at the top of the display area 402, and the second most downloaded game level 406 which in this case is the “Zelda level 45” is placed directly under the most downloaded game level 404, and so on.

In this example the user has selected (indicated by the thicker black line) the “Zelda level 45” downloadable game level 406, and may now by manoeuvring the navigational means 106 on the mobile phone, or the soft menu 408 presented in the display area 402, select, download, and install the “Zelda level 45”. Additionally each downloadable game level in this example has been rated using a three-star based rating system 410. As can be seen in the example in FIG. 4, the “Zelda level 67” has only been awarded two stars, while the second most downloaded game level “Zelda level 45” has been awarded three stars. In one variant of the present invention multiple top lists containing the same applications or downloadable content may simultaneously be provided to a user. In this way the user may select or brows between several different top lists which all are based on the users' context based information. For example, In addition to the top list shown in FIG. 4, a top list based on the user rating of the levels may also be provided.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments, variants, and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. System for providing a list to a mobile communication device, wherein the system comprises a mobile communication device and a server, and
wherein the mobile communication device comprises a first list of parameters of the activity in said mobile communication device,
wherein the server comprises a second list of parameters of activities of a number of second mobile communication devices,
wherein the mobile communication device is adapted to transmit the first list to the server,
wherein the server is adapted to receive said first list,
wherein the server is adapted to analyse said first list in relation to said second list,
wherein the server is adapted to derive a third list based on said analysis, and
wherein the mobile communication device is adapted to receive said third list.

2. The system according to claim 1, wherein said third list comprises features that can be supplied from the server.

3. The system according to claim 1, wherein said parameters comprises the frequency of the usage of one or more features.

4. The system according to claim 1, wherein said feature is an application to be executed in a mobile communication device.

5. The system according to claim 1, wherein information from the first list is added to the second list.

6. The system according to claim 1, further comprising a second server, wherein the server is adapted to transmit the third list to the second server, and wherein said second server is adapted to update said third list.

7. The system according to claim 1, further comprising a third server, wherein the server is adapted to transmit a result of the analysis to the third server, wherein said third server is adapted to derive the fourth list based on said analysis of said result, and
wherein said third server is adapted to transmit the fourth list to said mobile communication device.

8. A server for deriving a list,
wherein the server is adapted to receive a first list of parameters of activities from a mobile communication device,
wherein the server comprises a second list of parameters of activities of a number of second mobile communication devices,
said server is adapted to analyse said first list in relation to said second list,
said server is adapted to derive a third list based on said analysis,
wherein said server is adapted to transmit said third list.

9. The server according to claim 8, wherein the server is adapted to add information from the first list to the second list.

10. Method for a providing a list in a system comprising a mobile communication device and a server,
the mobile communication device generates a first list of parameters of the activity in said mobile communication device,
the mobile communication device transmits the first list to the server,
the server receives said first list,
the server analyses said first list in relation to a said second list comprising parameters of activities of a number of second mobile communication devices,
the server derives a third list based on said analysis,
and the mobile communication device receives said third list.

11. The method according to claim 10, wherein said third list comprises
features that can be supplied from the server.

12. The method according to claim 10, wherein said parameters comprises the frequency of the usage of one or more features.

13. The method according to claim 10, wherein said feature is an application to be executed in a mobile communication device.

14. The method according to claim 10, wherein information from the first list is added to the second list.

15. The method according to claim 10, wherein the system further comprising a second server, wherein the server transmits the third list to the second server, wherein said second server updates said third list.

16. The method according to claim 10, wherein the system further comprising a third server, wherein the server transmits a result of the analysis to the third server, wherein said third server derives the fourth list based on said analysis of said result,
and wherein third server said transmits the fourth list to said mobile communication device.
